(19) United States
(12) Patent Application Publication
(10) Pub. No.: US 2025/0044960 A1
(43) Pub. Date: Feb. 6, 2025

(54) CLOUD STORAGE ALLOCATION FOR EDGE DEVICE DATA

(71) Applicant: International Business Machines Corporation, Armonk, NY (US)

(72) Inventors: Christopher J. Vollmar, Mississauga (CA); Joseph W. Dain, Tucson, AZ (US); Krishnasuri Narayanam, BANGALORE (IN); Harald Seipp, Mainz (DE)

(73) Assignee: International Business Machines Corporation, Armonk, NY (US)

(21) Appl. No.: 18/229,919

(22) Filed: Aug. 3, 2023

(51) Int. Cl. G06F 3/06

(52) U.S. Cl. CPC G06F 3/0631; G06F 3/0604; G06F 3/067

(57) ABSTRACT

An embodiment classifies, by analyzing data generated by a first edge device, the data into a sensitivity category in a set of sensitivity categories. An embodiment classifies, by analyzing the data, the data into a redundancy category in a set of redundancy categories. An embodiment classifies, into a region category in a set of region categories, a region in which the first edge device is located. An embodiment selects, by applying a set of allocation rules, a storage category of the data generated by the first edge device, the selecting resulting in a selected storage category, the set of allocation rules applied according to the sensitivity category, the redundancy category, and the region category. An embodiment causes storage of the data generated by the first edge device in a storage device in the selected storage category.

### BACKGROUND

The present invention relates generally to cloud storage management. More particularly, the present invention relates to a method, system, and computer program for cloud storage allocation for edge device data.

A typical data processing application, particularly when collecting and processing data from one or more measurement devices, uses one or more edge devices, which measure or collect the data, and a cloud storage location, which stores data collected by one or more of the edge devices. Edge devices typically transmit data to a cloud storage location via a communication network such as the Internet. A cloud storage location typically includes a much higher storage capacity than an edge device, and collecting data from multiple, often geographically distributed, devices in a centralized location simplifies the application's data processing and provides for backups of the data an edge device collects.

### SUMMARY

The illustrative embodiments provide for cloud storage allocation for edge device data. An embodiment includes classifying, by analyzing data generated by a first edge device, the data into a sensitivity category in a set of sensitivity categories. An embodiment includes classifying, by analyzing the data, the data into a redundancy category in a set of redundancy categories. An embodiment includes classifying, into a region category in a set of region categories, a region in which the first edge device is located. An embodiment includes selecting, by applying a set of allocation rules, a storage category of the data generated by the first edge device, the selecting resulting in a selected storage category, the set of allocation rules applied according to the sensitivity category, the redundancy category, and the region category. An embodiment includes causing storage of the data generated by the first edge device in a storage device in the selected storage category. Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a flowchart of an example process for loading of process software in accordance with an illustrative embodiment;

FIG. 3 depicts a block diagram of an example configuration for cloud storage allocation for edge device data in accordance with an illustrative embodiment;

FIG. 4 depicts an example of cloud storage allocation for edge device data in accordance with an illustrative embodiment;

FIG. 5 depicts another example of cloud storage allocation for edge device data in accordance with an illustrative embodiment;

FIG. 6 depicts another example of cloud storage allocation for edge device data in accordance with an illustrative embodiment; and

FIG. 7 depicts a flowchart of an example process for cloud storage allocation for edge device data in accordance with an illustrative embodiment.

### DETAILED DESCRIPTION

The illustrative embodiments recognize that edge devices differ in terms of data processing speed, data transfer rate to a cloud storage location, how frequently data is sent to a cloud storage location, how much data is sent to a cloud storage location during a transmission or transmission session, and characteristics of the data (e.g., redundancy or compression factor). In addition, edge device behavior can change according to the time of day, time of year, in response or in anticipation of an event, in response to a configuration change, or another factor. Edge devices used in an application can also be located in geographically distributed locations, and those locations can be moving (e.g., in a vehicle) or fixed (e.g., in a building). For example, an airport weather monitoring system, configured as an edge device, might send less than a kilobyte of wind speed and direction data once per minute, while a set of video cameras in a sports stadium, configured as edge devices, might each send high-resolution streams of video data, but only when a game is in progress in the stadium.

The illustrative embodiments recognize that cloud storage locations differ in terms of capacity, cost, data acceptance rate, and other factors. Typically, a higher capacity or data acceptance rate costs more than a lower capacity or lower data acceptance rate. Cloud storage is often tiered, in a scheme in which higher tier storage comes with comparatively higher performance (e.g., higher throughput and lower latency) but costs more than lower tier storage, which comes with lower performance (e.g., lower throughput and higher latency). In addition, a user may prefer that an edge device and cloud storage location are in the same region (e.g., to improve application performance), or that a cloud storage location be located in a particular region or prevented from being located in a particular region (e.g., to comply with country- or region-specific data protection laws or regulations). Thus, the illustrative embodiments recognize that there is a need to configure an application's cloud storage location according to the application's edge device(s) and the data being sent, while avoiding incurring unneeded costs for unneeded performance or capacity.

The present disclosure addresses the deficiencies described above by providing a process (as well as a system, method, machine-readable medium, etc.) that, by analyzing data generated by a first edge device, classifies the data into a sensitivity category, a redundancy category, and a region category, selects a storage category of the data generated by the first edge device by applying a set of allocation rules according to the sensitivity category, the redundancy category, and the region category, and causes storage of the data generated by the first edge device in a storage device in the selected storage category. Thus, the illustrative embodiments provide for cloud storage allocation for edge device data.

An embodiment receives and analyzes data of an application for which a cloud storage location is to be allocated. The application can be already executing or in a pre-execution, configuration phase. In one embodiment, the data includes application requirements data, such as application throughput, latency, a maximum cost for the storage, a region specification (e.g., a preferred or required region, or a region that should be avoided or that is prohibited from use), a user's suggested or required storage specification, and the like. In another embodiment, the data includes requirements data that is not specific to a particular application, such as cost limits, data confidentiality requirements, approved cloud storage vendor data, contractual requirements, or requirements related to geographic boundaries. In another embodiment, the data includes edge device workload data such as whether an edge device only collects and forwards data or processes the data before forwarding, a value category of the data, whether a data provenance is needed, a data sensitivity measurement, a priority of the data versus data collected by one or more other edge devices, a risk of failure to collect data from a particular edge device, a region-based data protection or data use policy or government regulation, a cost preference, and the like. In another embodiment, the data includes edge device data metrics such as read and write data rates, a read/write balance in the data, a data file or portion size, whether or not the data is compressed or encrypted and which compression or encryption scheme is being used, a number of edge devices an application uses, a cache or buffer size or fill rate for an edge device, a data ingestion speed (average or peak), and the like. In another embodiment, the data includes data derived from an already-executing application such as current or forecast application throughput, latency, a current or forecast cost for the storage, a current or forecast region, and the like. The embodiment derives current or forecast application throughput, latency, and other application execution data using a presently available application execution monitoring or management technique.

An embodiment receives and analyzes edge device data for one or more edge devices being used, or that could be used, by an application for which a cloud storage location is to be allocated. The edge device data includes attributes such as a device's data processing rate, data transfer rate, region location or priority, and the like. The edge device data also includes attributes of the data produced by the edge device, such as the sampling rate of the data, how much data is produced, the data's time sensitivity, a level of confidentiality assigned to the data, a data access policy that applies to the data, an amount of personally identifiable information in the data, an amount of redundancy in the data, how quickly the data is changing or expected to change, and the like. One embodiment receives edge device data in the form of edge device requirements data. Another embodiment derives edge device data by using a presently available technique to monitor the data produced by one or more of the edge devices while the application executes.

An embodiment receives and analyzes data of a cloud storage location being used, or that could be used, by an application for which a cloud storage location is to be allocated. Some non-limiting examples of data of a cloud storage location include tier, cost, performance data, and a region in which a cloud storage location is located.

An embodiment receives and analyzes data of a network being used, or that could be used, by an application for which a cloud storage location is to be allocated. Some non-limiting examples of network data are the network's current or forecasted bandwidth, latency, link quality, maximum number of retries, target response time, as well as any regional variations.

An embodiment analyzes data generated by an edge device, as well as available application requirements data. Using the analyzed data, an embodiment classifies the data's sensitivity into one of a set of sensitivity categories. In one embodiment, data sensitivity refers to time sensitivity, i.e., how quickly the data is to be processed. For example, data that must be processed in real time might be assigned to the highest sensitivity category, and data with a less exacting time requirement (e.g., must be processed within one minute, one day, or one week) might be assigned to a lower sensitivity category. In another embodiment, data sensitivity refers to a confidentiality level or access control level of the data. For example, personally identifiable patient health data might be assigned to the highest sensitivity category and public data might be assigned to a lower sensitivity category, or data of an planned corporate merger might be assigned to the highest sensitivity category, data of a not-yet-released product might be assigned to a middle sensitivity category, and already-public data might be assigned to the lowest sensitivity category. One embodiment uses two sensitivity categories (i.e., an edge device's data is classified into the high or low category). Another embodiment uses three sensitivity categories (i.e., an edge device's data is classified into the high, middle, or low categories). Other categorization schemes are also possible and contemplated within the scope of the illustrative embodiments. Techniques are presently available to analyze data and select a sensitivity category, including content-based classification (i.e., by inspecting the data itself), context-based classification (i.e., using application, location, or creator, or other data as an indirect sensitivity indicator), and user-based classification (i.e., using a tag or annotation supplied by a user). Machine learning-based content and context-based classification techniques are also presently available.

An embodiment analyzes data generated by an edge device, as well as available application requirements data. Using the analyzed data, an embodiment classifies the data's redundancy into one of a set of redundancy categories. One embodiment uses two redundancy categories (i.e., an edge device's data is classified into the high or low category). Another embodiment uses three redundancy categories (i.e., an edge device's data is classified into the high, middle, or low categories). Other categorization schemes are also possible and contemplated within the scope of the illustrative embodiments. Data redundancy includes repeated information, irrelevant information, over-detailed information. Some presently available techniques for determining data redundancy, using machine learning or other techniques, are value similarity-based grouping, learning-based methods, projection, implicit detection, and using a set of heuristics.

An embodiment classifies a region in which an edge device is located into a region category in a set of region categories. One embodiment uses three region categories (e.g., AMER (North and South America), EMEA (Europe, the Middle East, and Africa), and APAC (Asia, Australia, New Zealand and other areas in the Pacific Ocean). Another embodiment uses region categories formed according to applicable data protection laws and regulations in each region (e.g., separate regions for the European Union, the United States, Canada, and the United Kingdom, as well as other countries). Other region categorization schemes are also possible and contemplated within the scope of the illustrative embodiments. In one embodiment, the region category indicates a priority, for example based on a user's annotation of a particular region (and hence all the edge devices within that region), based on the number of edge devices deployed in a particular region, based on a rate at which edge device(s) in a region generate data, based on application requirements or a type of processing an application applies to data obtained from different regions, or a combination. In another embodiment, the region category indicates a region in which an edge device's data must be stored. For example, to comply with European Union data protection requirements, it may be desirable to generate, process, and store some data wholly within the European Union.

An embodiment selects, by applying a set of allocation rules, a storage category of the data generated by an edge device. Two non-limiting examples of a storage category are a region category (e.g., using the same scheme as was used for categorizing an edge device's region), and a tier (e.g., where tier 1 denotes the highest category of performance and cost, and lower tiers denote progressively lower categories of performance and cost). In one example allocation rule, if the edge device data is in the highest sensitivity category (i.e., most sensitive), use the highest-performance storage category (e.g., tier 1). In another example allocation rule, if the edge device data is in the highest redundancy category (i.e., most redundant), use the lowest-performance storage category (e.g., tier 3 in a 3-tier scheme). In another example allocation rule, if the edge device data is not in the highest sensitivity category and not in the highest redundancy category, select a storage category according to an overall data generation rate of all of the edge devices an application uses. In another example allocation rule, an edge device uses storage in the same region as the edge device. In another example allocation rule, when there is more than one edge device, and the edge devices are in different region categories based on a region priority, select a storage category based on the needs and categories of one or more edge devices in the region category with the highest priority. In another example allocation rule, when an application-specific storage requirement has been specified (e.g., the cameras in a stadium need the highest-possible storage category and a specified amount of storage space during events at the stadium, but can revert to the lowest-possible storage category when events are not in progress), allocate storage according to the specified storage requirement. Other allocation rules are also possible and contemplated within the scope of the illustrative embodiments.

If two allocation rules conflict with each other (e.g., one rule results in the highest storage category while another rule results in the lowest storage category) one embodiment selects the highest storage category (i.e., best performing) of the possible storage categories, so as not to compromise application performance. Another embodiment resolves rule conflicts by assigning a priority to each allocation rule and using the conflicting rule with the highest priority. Another embodiment resolves rule conflicts by assigning a priority to each allocation rule and computing a weighted aggregate of the conflicting rules. Another embodiment resolves rule conflicts by asking a human expert to resolve the conflict.

Another embodiment uses a presently available optimization model, trained using a presently available machine learning technique, to select a storage category of the data generated by an edge device.

If necessary, an embodiment allocates a storage device, or a portion of a storage device, in the selected storage category for use by an edge device. One embodiment allocates a storage device, or a portion of a storage device, prior to an edge device's storage access. Another embodiment allocates a storage device, or a portion of a storage device, concurrently with an edge device's storage access, for example to provide additional data storage or to adjust an edge device's storage to more closely conform with the device's or an application's actual behavior. An embodiment causes storage of data generated by an edge device in a storage device in the selected storage category.

An embodiment periodically reanalyzes data generated by an edge device or updated application requirements data to adjust one or more of an edge device's sensitivity, redundancy, and region categories, and reapplies the set of allocation rules to adjust a storage category of the data generated by the edge device, thus adapting a selected storage category to changing conditions. For example, a lower-cost storage option might now be available, a set of cameras providing ski resort coverage might have different data generation rates in the winter and the summer, or an edge device might have been upgraded to include more sensors and a higher data generation rate.

An embodiment periodically reanalyzes an application's performance using a selected storage category, and uses a presently available machine learning technique to adjust one or more allocation rules, generate one or more additional allocation rules, adjust an allocation rule priority, or update a machine-learning-based optimization model.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), crasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

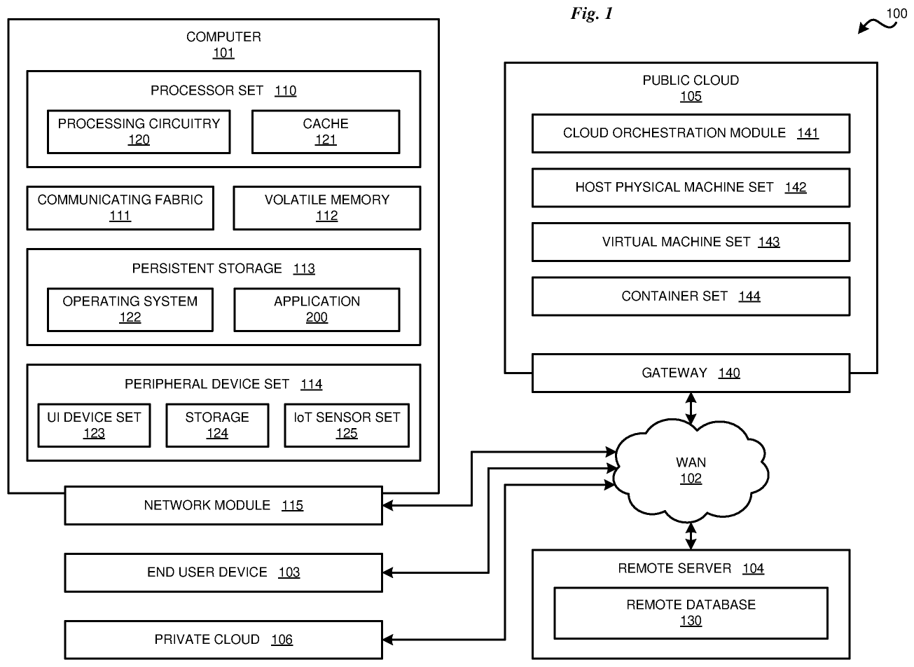

With reference to FIG. 1, this figure depicts a block diagram of a computing environment 100. Computing environment 100 contains an example of an environment for the execution of at least some of the computer code involved in performing the inventive methods, such as an application 200 that provides cloud storage allocation for edge device data. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

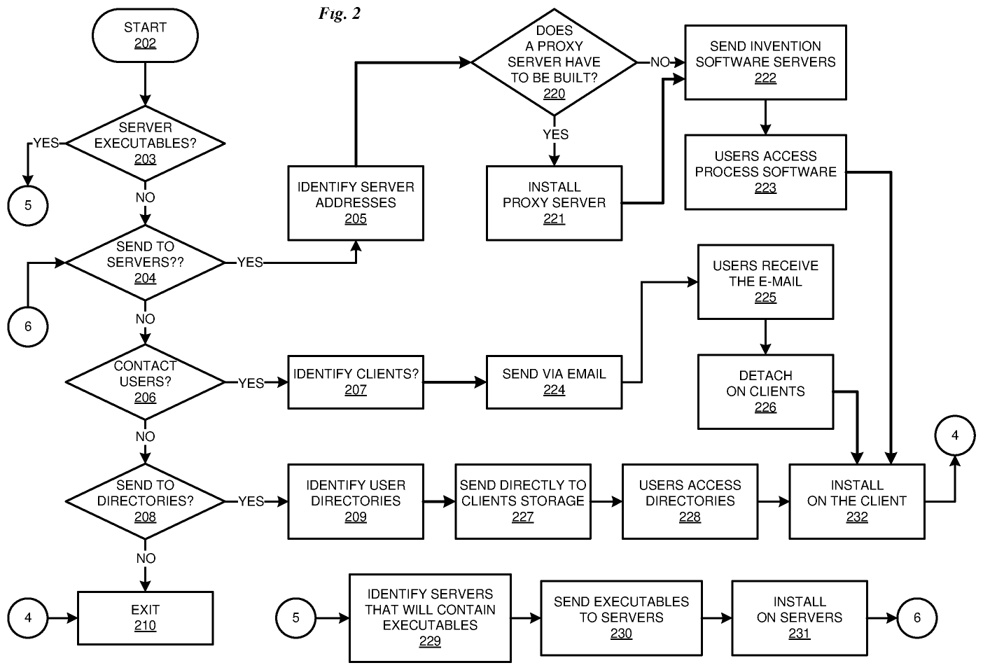

With reference to FIG. 2, this figure depicts a flowchart of an example process for loading of process software in accordance with an illustrative embodiment. The flowchart can be executed by a device such as computer 101, end user device 103, remote server 104, or a device in private cloud 106 or public cloud 105 in FIG. 1.

While it is understood that the process software implementing cloud storage allocation for edge device data may be deployed by manually loading it directly in the client, server, and proxy computers via loading a storage medium such as a CD, DVD, etc., the process software may also be automatically or semi-automatically deployed into a computer system by sending the process software to a central server or a group of central servers. The process software is then downloaded into the client computers that will execute the process software. Alternatively, the process software is sent directly to the client system via e-mail. The process software is then either detached to a directory or loaded into a directory by executing a set of program instructions that detaches the process software into a directory. Another alternative is to send the process software directly to a directory on the client computer hard drive. When there are proxy servers, the process will select the proxy server code, determine on which computers to place the proxy servers' code, transmit the proxy server code, and then install the proxy server code on the proxy computer. The process software will be transmitted to the proxy server, and then it will be stored on the proxy server.

Step 202 begins the deployment of the process software. An initial step is to determine if there are any programs that will reside on a server or servers when the process software is executed (203). If this is the case, then the servers that will contain the executables are identified (229). The process software for the server or servers is transferred directly to the servers' storage via FTP or some other protocol or by copying though the use of a shared file system (230). The process software is then installed on the servers (231).

Next, a determination is made on whether the process software is to be deployed by having users access the process software on a server or servers (204). If the users are to access the process software on servers, then the server addresses that will store the process software are identified (205).

A determination is made if a proxy server is to be built (220) to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required, then the proxy server is installed (221). The process software is sent to the (one or more) servers either via a protocol such as FTP, or it is copied directly from the source files to the server files via file sharing (222). Another embodiment involves sending a transaction to the (one or more) servers that contained the process software, and have the server process the transaction and then receive and copy the process software to the server's file system. Once the process software is stored at the servers, the users via their client computers then access the process software on the servers and copy to their client computers file systems (223). Another embodiment is to have the servers automatically copy the process software to each client and then run the installation program for the process software at each client computer. The user executes the program that installs the process software on his client computer (232) and then exits the process (210).

In step 206 a determination is made whether the process software is to be deployed by sending the process software to users via e-mail. The set of users where the process software will be deployed are identified together with the addresses of the user client computers (207). The process software is sent via e-mail to each of the users' client computers (224). The users then receive the e-mail (225) and then detach the process software from the e-mail to a directory on their client computers (226). The user executes the program that installs the process software on his client computer (232) and then exits the process (210).

Lastly, a determination is made on whether the process software will be sent directly to user directories on their client computers (208). If so, the user directories are identified (209). The process software is transferred directly to the user's client computer directory (227). This can be done in several ways such as, but not limited to, sharing the file system directories and then copying from the sender's file system to the recipient user's file system or, alternatively, using a transfer protocol such as File Transfer Protocol (FTP). The users access the directories on their client file systems in preparation for installing the process software (228). The user executes the program that installs the process software on his client computer (232) and then exits the process (210).

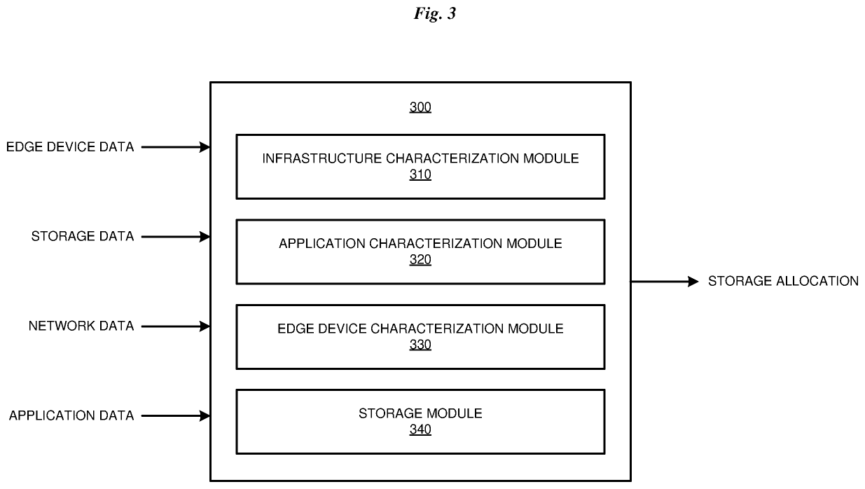

With reference to FIG. 3, this figure depicts a block diagram of an example configuration for cloud storage allocation for edge device data in accordance with an illustrative embodiment. Application 300 is the same as application 200 in FIG. 1.

In the illustrated embodiment, application characterization module 320 receives and analyzes data of an application for which a cloud storage location is to be allocated. The application can be already executing or in a pre-execution, configuration phase. In one implementation of module 320, the data includes application requirements data, such as application throughput, latency, a maximum cost for the storage, a region specification (e.g., a preferred or required region, or a region that should be avoided or that is prohibited from use), a user's suggested or required storage specification, and the like. In another implementation of module 320, the data includes requirements data that is not specific to a particular application, such as cost limits, data confidentiality requirements, approved cloud storage vendor data, contractual requirements, or requirements related to geographic boundaries. In another implementation of module 320, the data includes edge device workload data such as whether an edge device only collects and forwards data or processes the data before forwarding, a value category of the data, whether a data provenance is needed, a data sensitivity measurement, a priority of the data versus data collected by one or more other edge devices, a risk of failure to collect data from a particular edge device, a region-based data protection or data use policy or government regulation, a cost preference, and the like. In another implementation of module 320, the data includes edge device data metrics such as read and write data rates, a read/write balance in the data, a data file or portion size, whether or not the data is compressed or encrypted and which compression or encryption scheme is being used, a number of edge devices an application uses, a cache or buffer size or fill rate for an edge device, a data ingestion speed (average or peak), and the like. In another implementation of module 320, the data includes data derived from an already-executing application such as current or forecast application throughput, latency, a current or forecast cost for the storage, a current or forecast region, and the like. The implementation derives current or forecast application throughput, latency, and other application execution data using a presently available application execution monitoring or management technique.

Edge device characterization module 330 receives and analyzes edge device data for one or more edge devices being used, or that could be used, by an application for which a cloud storage location is to be allocated. The edge device data includes attributes such as a device's data processing rate, data transfer rate, region location or priority, and the like. The edge device data also includes attributes of the data produced by the edge device, such as the sampling rate of the data, how much data is produced, the data's time sensitivity, a level of confidentiality assigned to the data, a data access policy that applies to the data, an amount of personally identifiable information in the data, an amount of redundancy in the data, how quickly the data is changing or expected to change, and the like. One implementation of module 330 receives edge device data in the form of edge device requirements data. Another implementation of module 330 derives edge device data by using a presently available technique to monitor the data produced by one or more of the edge devices while the application executes.

Infrastructure characterization module 310 receives and analyzes data of a cloud storage location being used, or that could be used, by an application for which a cloud storage location is to be allocated. Some non-limiting examples of data of a cloud storage location include tier, cost, performance data, and a region in which a cloud storage location is located.

Infrastructure characterization module 310 receives and analyzes data of a network being used, or that could be used, by an application for which a cloud storage location is to be allocated. Some non-limiting examples of network data are the network's current or forecasted bandwidth, latency, link quality, maximum number of retries, target response time, as well as any regional variations.

Edge device characterization module 330 analyzes data generated by an edge device, as well as available application requirements data. Using the analyzed data, module 330 classifies the data's sensitivity into one of a set of sensitivity categories. In one implementation of module 330, data sensitivity refers to time sensitivity, i.e., how quickly the data is to be processed. In another implementation of module 330, data sensitivity refers to a confidentiality level or access control level of the data. One implementation of module 330 uses two sensitivity categories (i.e., an edge device's data is classified into the high or low category). Another implementation of module 330 uses three sensitivity categories (i.e., an edge device's data is classified into the high, middle, or low categories). Other categorization schemes are also possible. Techniques are presently available to analyze data and select a sensitivity category, including content-based classification (i.e., by inspecting the data itself), context-based classification (i.e., using application, location, or creator, or other data as an indirect sensitivity indicator), and user-based classification (i.e., using a tag or annotation supplied by a user). Machine learning-based content and context-based classification techniques are also presently available.

Edge device characterization module 330 analyzes data generated by an edge device, as well as available application requirements data. Using the analyzed data, module 330 classifies the data's redundancy into one of a set of redundancy categories. One implementation of module 330 uses two redundancy categories (i.e., an edge device's data is classified into the high or low category). Another implementation of module 330 uses three redundancy categories (i.e., an edge device's data is classified into the high, middle, or low categories). Other categorization schemes are also possible and contemplated within the scope of the illustrative embodiments. Data redundancy includes repeated information, irrelevant information, over-detailed information. Some presently available techniques for determining data redundancy, using machine learning or other techniques, are value similarity-based grouping, learning-based methods, projection, implicit detection, and using a set of heuristics.

Edge device characterization module 330 classifies a region in which an edge device is located into a region category in a set of region categories. One implementation of module 330 uses three region categories (e.g., AMER (North and South America), EMEA (Europe, the Middle East, and Africa), and APAC (Asia, Australia, New Zealand and other areas in the Pacific Ocean). Another implementation of module 330 uses region categories formed according to applicable data protection laws and regulations in each region (e.g., separate regions for the European Union, the United States, Canada, and the United Kingdom, as well as other countries). Other region categorization schemes are also possible and contemplated within the scope of the illustrative embodiments. In one implementation of module 330, the region category indicates a priority, for example based on a user's annotation of a particular region (and hence all the edge devices within that region), based on the number of edge devices deployed in a particular region, based on a rate at which edge device(s) in a region generate data, based on application requirements or a type of processing an application applies to data obtained from different regions, or a combination. In another implementation of module 330, the region category indicates a region in which an edge device's data must be stored. For example, to comply with European Union data protection requirements, it may be desirable to generate, process, and store some data wholly within the European Union.

Storage module 340 selects, by applying a set of allocation rules, a storage category of the data generated by an edge device. Two non-limiting examples of a storage category are a region category (e.g., using the same scheme as was used for categorizing an edge device's region), and a tier (e.g., where tier 1 denotes the highest category of performance and cost, and lower tiers denote progressively lower categories of performance and cost). In one example allocation rule, if the edge device data is in the highest sensitivity category (i.e., most sensitive), use the highest-performance storage category (e.g., tier 1). In another example allocation rule, if the edge device data is in the highest redundancy category (i.e., most redundant), use the lowest-performance storage category (e.g., tier 3 in a 3-tier scheme). In another example allocation rule, if the edge device data is not in the highest sensitivity category and not in the highest redundancy category, select a storage category according to an overall data generation rate of all of the edge devices an application uses. In another example allocation rule, an edge device uses storage in the same region as the edge device. In another example allocation rule, when there is more than one edge device, and the edge devices are in different region categories based on a region priority, select a storage category based on the needs and categories of one or more edge devices in the region category with the highest priority. In another example allocation rule, when an application-specific storage requirement has been specified (e.g., the cameras in a stadium need the highest-possible storage category and a specified amount of storage space during events at the stadium, but can revert to the lowest-possible storage category when events are not in progress), allocate storage according to the specified storage requirement. Other allocation rules are also possible and contemplated within the scope of the illustrative embodiments.

If two allocation rules conflict with each other (e.g., one rule results in the highest storage category while another rule results in the lowest storage category) one implementation of module 340 selects the highest storage category (i.e., best performing) of the possible storage categories, so as not to compromise application performance. Another implementation of module 340 resolves rule conflicts by assigning a priority to each allocation rule and using the conflicting rule with the highest priority. Another implementation of module 340 resolves rule conflicts by assigning a priority to each allocation rule and computing a weighted aggregate of the conflicting rules. Another implementation of module 340 resolves rule conflicts by asking a human expert to resolve the conflict.

Another implementation of module 340 uses a presently available optimization model, trained using a presently available machine learning technique, to select a storage category of the data generated by an edge device.

If necessary, module 340 allocates a storage device, or a portion of a storage device, in the selected storage category for use by an edge device. One implementation of module 340 allocates a storage device, or a portion of a storage device, prior to an edge device's storage access. Another implementation of module 340 allocates a storage device, or a portion of a storage device, concurrently with an edge device's storage access, for example to provide additional data storage or to adjust an edge device's storage to more closely conform with the device's or an application's actual behavior. Module 340 causes storage of data generated by an edge device in a storage device in the selected storage category.

Application 300 periodically reanalyzes data generated by an edge device or updated application requirements data to adjust one or more of an edge device's sensitivity, redundancy, and region categories, and reapplies the set of allocation rules to adjust a storage category of the data generated by the edge device, thus adapting a selected storage category to changing conditions. For example, a lower-cost storage option might now be available, a set of cameras providing ski resort coverage might have different data generation rates in the winter and the summer, or an edge device might have been upgraded to include more sensors and a higher data generation rate.

Application 300 periodically reanalyzes an application's performance using a selected storage category, and uses a presently available machine learning technique to adjust one or more allocation rules, generate one or more additional allocation rules, adjust an allocation rule priority, or update a machine-learning-based optimization model.

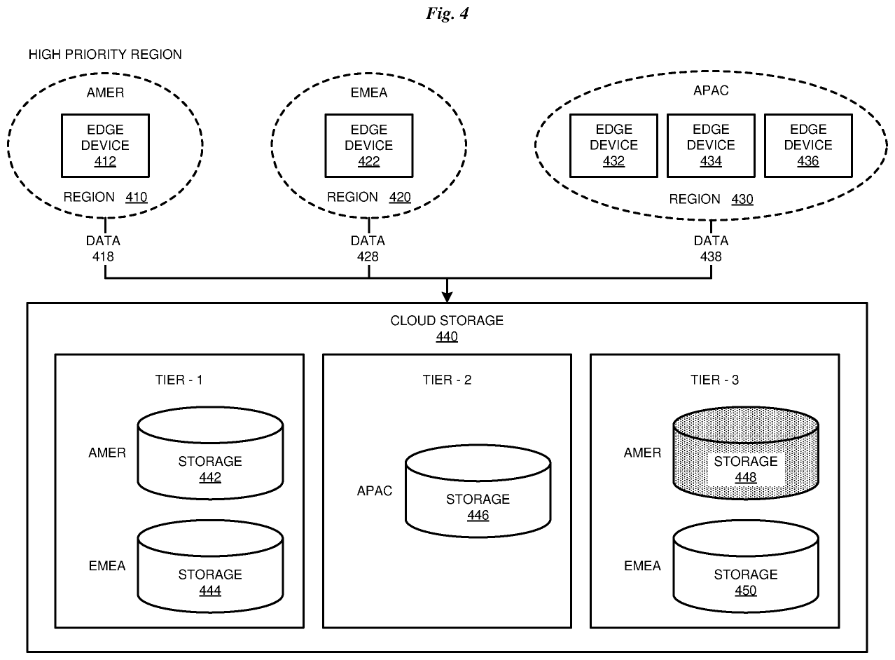

With reference to FIG. 4, this figure depicts an example of cloud storage allocation for edge device data in accordance with an illustrative embodiment. The example can be executed using application 300 in FIG. 3.

As depicted, edge device 412 is located in region 410, a high priority region. Edge device 422 is located in region 420, and edge devices 432, 434, and 436 are located in region 430. Edge device 412 sends data 418 to cloud storage 440 for storage. Edge device 422 sends data 428 to cloud storage 440 for storage. Edge devices 432, 434, and 436 send data 438 to cloud storage 440 for storage. Within cloud storage 440, storage 442 is in region 410 and is in the tier 1 category. Storage 444 is in region 420 and is also in the tier 1 category. Storage 446 is in region 430 and is in the tier 2 category. Storage 448 is in region 410 and is in the tier 3 category. Storage 450 is in region 420 and is in the tier 3 category.

Here, region 410 has been designated as a high priority region, and data from the edge devices has not been characterized as in the highest sensitivity or redundancy categories. Based on provided application requirements, application 300 has selected tier 3 as the storage category from which storage is to be allocated. Thus, since storage 448 is in region 410—high priority region—and in the tier 3 category, application 300 selects storage 448, and causes data from all of the edge devices to be stored in storage 448.

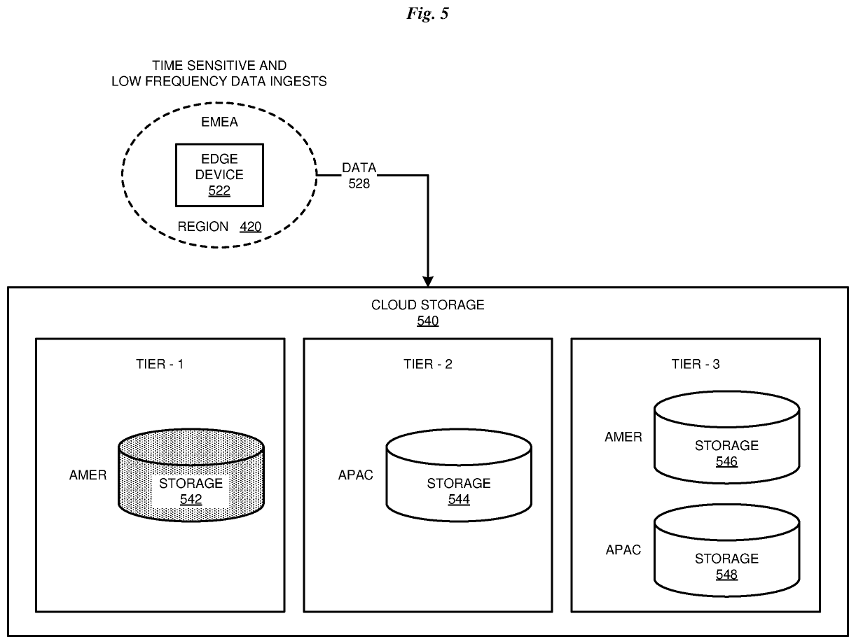

With reference to FIG. 5, this figure depicts another example of cloud storage allocation for edge device data in accordance with an illustrative embodiment. The example can be executed using application 300 in FIG. 3. Region 420 is the same as region 420 in FIG. 4.

As depicted, edge device 522 is located in region 420. Edge device 522 collects time sensitive data at a comparatively low frequency, and sends data 528 to cloud storage 540 for storage. Within cloud storage 540, storage 542 is in region 410 and is in the tier 1 category. Storage 544 is in region 430 and is in the tier 2 category. Storage 546 is in region 410 and is in the tier 3 category. Storage 548 is in region 420 and is in the tier 3 category.

Here, because edge device 522 has been classified into the highest time sensitivity category, the tier 1 storage category has been selected. Thus, application 300 selects storage 542, in the tier 1 category, and causes data from edge device 522 to be stored in storage 542, even though storage 542 is not in the same region as edge device 522.

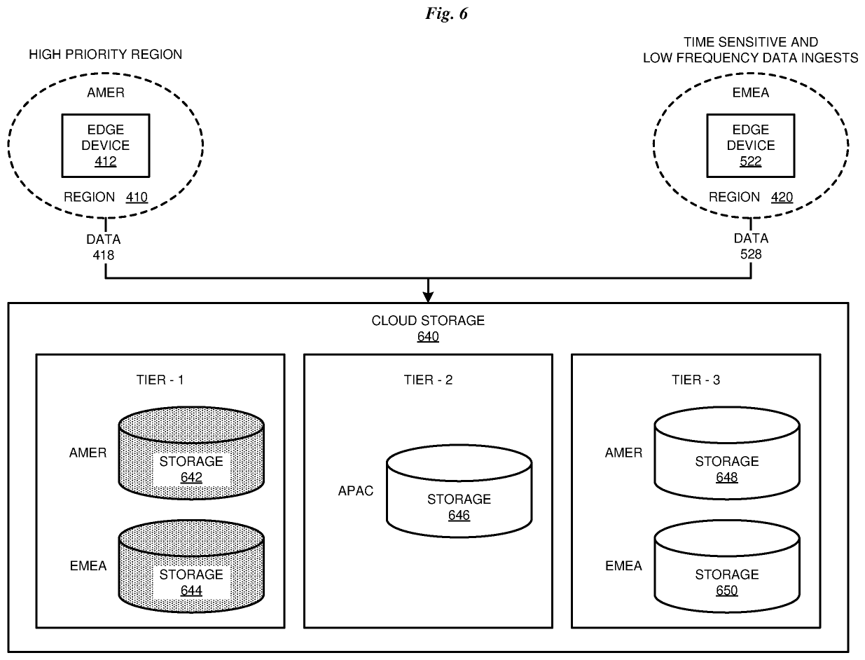

With reference to FIG. 6, this figure depicts another example of cloud storage allocation for edge device data in accordance with an illustrative embodiment. The example can be executed using application 300 in FIG. 3. Regions 410 and 420, edge device 412, and data 418 are the same as regions 410 and 420, edge device 412, and data 418 in FIG. 4. Edge device 522 and data 528 are the same as edge device 522 and data 528 in FIG. 5.

As depicted, edge device 412 is located in region 410, a high priority region. Edge device 522 is located in region 420. Edge device 522 collects time sensitive data at a comparatively low frequency, and sends data 528 to cloud storage 640 for storage. Edge device 412 sends data 418 to cloud storage 640 for storage. Within cloud storage 640, storage 642 is in region 410 and is in the tier 1 category. Storage 644 is in region 420 and is also in the tier 1 category. Storage 646 is in region 430 and is in the tier 2 category. Storage 648 is in region 410 and is in the tier 3 category. Storage 650 is in region 420 and is in the tier 3 category.

Here, because edge device 522 has been classified into the highest time sensitivity category, the tier 1 storage category has been selected. (Based on provided application requirements, application 300 could have selected tier 3 as the storage category for data from edge device 412, but the higher-performance needs of edge device 522 take precedence.) Within tier 1, application 300 selects storage 642 (in region 410, the high priority region) for data from both edge devices. Alternatively, application 300 selects storage 642 (in region 410, the high priority region) for data from edge device 412 in region 410, and selects storage 644 for data from edge device 522 in region 420. Alternatively, application 300 computes a weighted aggregate of conflicting allocation rules to select one of storage 642 and storage 644, or a combination of the two. Application 300 causes data from edge devices 412 and 522 to be stored in the selected storage device.

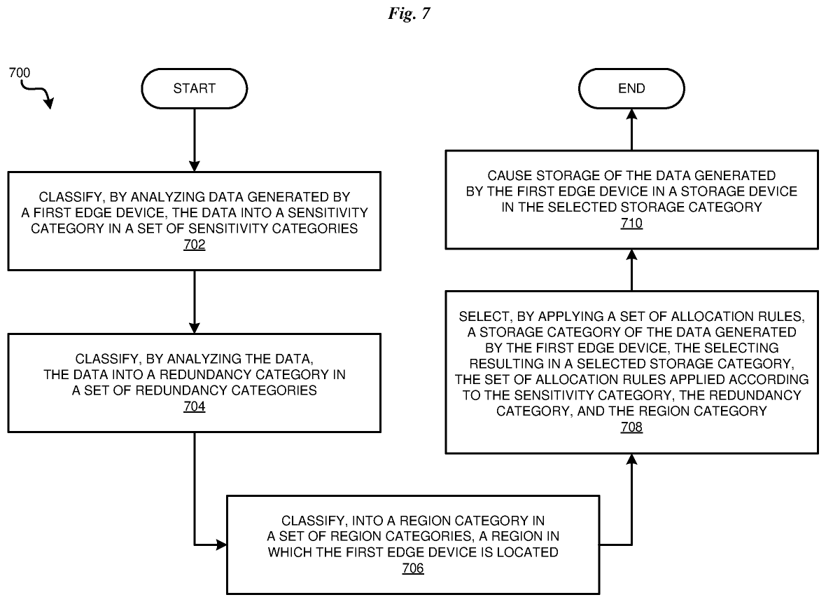

With reference to FIG. 7, this figure depicts a flowchart of an example process for cloud storage allocation for edge device data in accordance with an illustrative embodiment. Process 700 can be implemented in application 200 in FIG. 3.

In the illustrated embodiment, at block 702, the process classifies, by analyzing data generated by a first edge device, the data into a sensitivity category in a set of sensitivity categories. At block 704, the process classifies, by analyzing the data, the data into a redundancy category in a set of redundancy categories. At block 706, the process classifies, into a region category in a set of region categories, a region in which the first edge device is located. At block 708, the process selects, by applying a set of allocation rules, a storage category of the data generated by the first edge device, the selecting resulting in a selected storage category, the set of allocation rules applied according to the sensitivity category, the redundancy category, and the region category. At block 710, the process causes storage of the data generated by the first edge device in a storage device in the selected storage category. Then the process ends.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of +8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
classifying, by analyzing data generated by a first edge device, the data into a sensitivity category in a set of sensitivity categories;
classifying, by analyzing the data, the data into a redundancy category in a set of redundancy categories;
classifying, into a region category in a set of region categories, a region in which the first edge device is located;
selecting, by applying a set of allocation rules, a storage category of the data generated by the first edge device, the selecting resulting in a selected storage category, the set of allocation rules applied according to the sensitivity category, the redundancy category, and the region category; and
causing storage of the data generated by the first edge device in a storage device in the selected storage category.

2. The computer-implemented method of claim 1, wherein an allocation rule in the set of allocation rules comprises selecting, responsive to determining that the data is in a highest sensitivity category in the set of sensitivity categories, a highest-performance storage category in the set of storage categories.

3. The computer-implemented method of claim 1, wherein an allocation rule in the set of allocation rules comprises selecting, responsive to determining that the data is in a highest redundancy category in the set of redundancy categories, a lowest-performance storage category in the set of storage categories.

4. The computer-implemented method of claim 1, wherein applying the set of allocation rules comprises selecting, responsive to determining that a first allocation rule in the set of allocation rules selects a first storage category and a second allocation rule in the set of allocation rules selects a second storage category, the first storage category, wherein the first storage category is a higher performance category than the second storage category.

5. The computer-implemented method of claim 1, wherein the storage device is in the region category.

6. The computer-implemented method of claim 1, wherein the storage device is in a second region category, the second region category selected according to a number of edge devices classified into the second region category relative to a number of edge devices classified into the region category.

7. A computer program product comprising one or more computer readable storage media, and program instructions collectively stored on the one or more computer readable storage media, the program instructions executable by a processor to cause the processor to perform operations comprising:
classifying, by analyzing data generated by a first edge device, the data into a sensitivity category in a set of sensitivity categories;
classifying, by analyzing the data, the data into a redundancy category in a set of redundancy categories;
classifying, into a region category in a set of region categories, a region in which the first edge device is located;
selecting, by applying a set of allocation rules, a storage category of the data generated by the first edge device, the selecting resulting in a selected storage category, the set of allocation rules applied according to the sensitivity category, the redundancy category, and the region category; and
causing storage of the data generated by the first edge device in a storage device in the selected storage category.

8. The computer program product of claim 7, wherein the stored program instructions are stored in a computer readable storage device in a data processing system, and wherein the stored program instructions are transferred over a network from a remote data processing system.

9. The computer program product of claim 7, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

10. The computer program product of claim 7, wherein an allocation rule in the set of allocation rules comprises selecting, responsive to determining that the data is in a highest sensitivity category in the set of sensitivity categories, a highest-performance storage category in the set of storage categories.

11. The computer program product of claim 7, wherein an allocation rule in the set of allocation rules comprises selecting, responsive to determining that the data is in a highest redundancy category in the set of redundancy categories, a lowest-performance storage category in the set of storage categories.

12. The computer program product of claim 7, wherein applying the set of allocation rules comprises selecting, responsive to determining that a first allocation rule in the set of allocation rules selects a first storage category and a second allocation rule in the set of allocation rules selects a second storage category, the first storage category, wherein the first storage category is a higher performance category than the second storage category.

13. The computer program product of claim 7, wherein the storage device is in the region category.

14. The computer program product of claim 7, wherein the storage device is in a second region category, the second region category selected according to a number of edge devices classified into the second region category relative to a number of edge devices classified into the region category.

15. A computer system comprising a processor and one or more computer readable storage media, and program instructions collectively stored on the one or more computer readable storage media, the program instructions executable by the processor to cause the processor to perform operations comprising:
classifying, by analyzing data generated by a first edge device, the data into a sensitivity category in a set of sensitivity categories;
classifying, by analyzing the data, the data into a redundancy category in a set of redundancy categories;
classifying, into a region category in a set of region categories, a region in which the first edge device is located;
selecting, by applying a set of allocation rules, a storage category of the data generated by the first edge device, the selecting resulting in a selected storage category, the set of allocation rules applied according to the sensitivity category, the redundancy category, and the region category; and
causing storage of the data generated by the first edge device in a storage device in the selected storage category.

16. The computer system of claim 15, wherein an allocation rule in the set of allocation rules comprises selecting, responsive to determining that the data is in a highest sensitivity category in the set of sensitivity categories, a highest-performance storage category in the set of storage categories.

17. The computer system of claim 15, wherein an allocation rule in the set of allocation rules comprises selecting, responsive to determining that the data is in a highest redundancy category in the set of redundancy categories, a lowest-performance storage category in the set of storage categories.

18. The computer system of claim 15, wherein applying the set of allocation rules comprises selecting, responsive to determining that a first allocation rule in the set of allocation rules selects a first storage category and a second allocation rule in the set of allocation rules selects a second storage category, the first storage category, wherein the first storage category is a higher performance category than the second storage category.

19. The computer system of claim 15, wherein the storage device is in the region category.

20. The computer system of claim 15, wherein the storage device is in a second region category, the second region category selected according to a number of edge devices classified into the second region category relative to a number of edge devices classified into the region category.
